(19) United States
(12) Patent Application Publication
(10) Pub. No.: US 2026/0184157 A1
(43) Pub. Date: Jul. 2, 2026

(54) ALIGNMENT METHOD AND APPARATUS FOR ELECTRIC VEHICLE BATTERY TRANSFER

(71) Applicant: Robert Bosch GmbH, Stuttgart (DE)

(72) Inventor: Daniel Newkirk, Owatanna, MN (US)

(21) Appl. No.: 19/412,934

(22) Filed: Dec. 9, 2025

Related U.S. Application Data
(60) Provisional application No. 63/740,006, filed on Dec. 30, 2024.

(51) Int. Cl. B60K 1/04

(52) U.S. Cl. CPC B60K 1/04; B60K 2001/0438; B60K 2001/0472

(57) ABSTRACT

A lift alignment apparatus and method utilizing a number of crosshair projectors to project a crosshair onto a destination for an electric vehicle battery during a transfer operation. The crosshair projectors are positioned such that aligning each of the projected crosshairs onto a specified target locus of the destination from a designated emitter locus of the origin will result in an alignment of the vehicle chassis and a battery lift for a transfer operation.

### TECHNICAL FIELD

This disclosure relates to tools for vehicle service and repair. More specifically, this disclosure relates to the transfer of electric vehicle batteries between an associated vehicle chassis and a battery lift, and tools for the transfer.

### BACKGROUND

Service of electric vehicles frequently requires removal of electric vehicle batteries (EVBs) from the vehicle chassis. EVBs are typically quite heavy, and safe transfer of the battery into or out of the vehicle chassis relies upon a battery lift to securely move the battery in a safe manner. Alignment of the battery lift with the vehicle chassis is crucial to ensure safe operating conditions during the transfer. What is desired is a simple and effective way to visually ensure alignment of the battery lift with a vehicle for a transfer operation.

### SUMMARY

One aspect of this disclosure is directed to a method of transferring an electric vehicle battery (EVB) between a vehicle chassis and a battery lift. The method comprises steps of leveling a planar support of the battery lift, inserting each of a plurality of crosshair projectors into an emitter locus, aligning the battery lift relative to the vehicle chassis such that each emitted crosshair aligns to a corresponding target locus for the EVB concurrently, moving the planar support surface relative to the vehicle chassis such that the EVB is transferable between the vehicle chassis and the battery lift, and transferring the EVB to the battery lift. Each of the emitter loci corresponds to a designated alignment position of the EVB. In some embodiments the designated emitter loci may be on the battery lift and the target loci may be on the vehicle chassis. In other embodiments, the designated emitter loci may be on the vehicle chassis and the target loci may be on the battery lift.

Another aspect of this disclosure is directed to a method of transferring an electric vehicle battery (EVB) between a battery lift and vehicle chassis. The method comprises steps of leveling a planar support of the battery lift, inserting each of a plurality of crosshair projectors into an emitter locus, aligning the battery lift relative to the vehicle chassis such that each emitted crosshair aligns to a corresponding target locus for the EVB concurrently, moving the planar support surface relative to the vehicle chassis such that the EVB is transferable between the vehicle chassis and the battery lift, and transferring the EVB to the vehicle chassis. Each of the emitter loci corresponds to a designated alignment position of the EVB. In some embodiments the designated emitter loci may be on the battery lift and the target loci may be on the vehicle chassis. In other embodiments, the designated emitter loci may be on the vehicle chassis and the target loci may be on the battery lift.

A further aspect of this disclosure is directed to a lift alignment apparatus comprising a level tool and a number of crosshair projectors. The level tool is a 2-dimensional level tool. Each crosshair projector has a body with an emission portion and a mounting portion disposed opposite from the emission portion. The mounting portion has coupling mechanism compatible with a mounting portion of a battery lift.

The above aspects of this disclosure and other aspects will be explained in greater detail below with reference to the attached drawings.

### BRIEF DESCRIPTION OF THE DRAWINGS

FIG. 1 is an illustration of an alignment apparatus.

FIG. 2 is closeup illustration of a crosshair projector of an alignment apparatus.

FIG. 3 is an illustration of an alignment between a battery lift and a vehicle in a first alignment configuration.

FIG. 4 is an illustration of an alignment between a battery lift and a vehicle in a second alignment configuration.

FIG. 5 is a close-up illustration of an alignment between a battery lift and vehicle.

FIG. 6 is a flowchart illustrating a method of alignment using an alignment apparatus.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

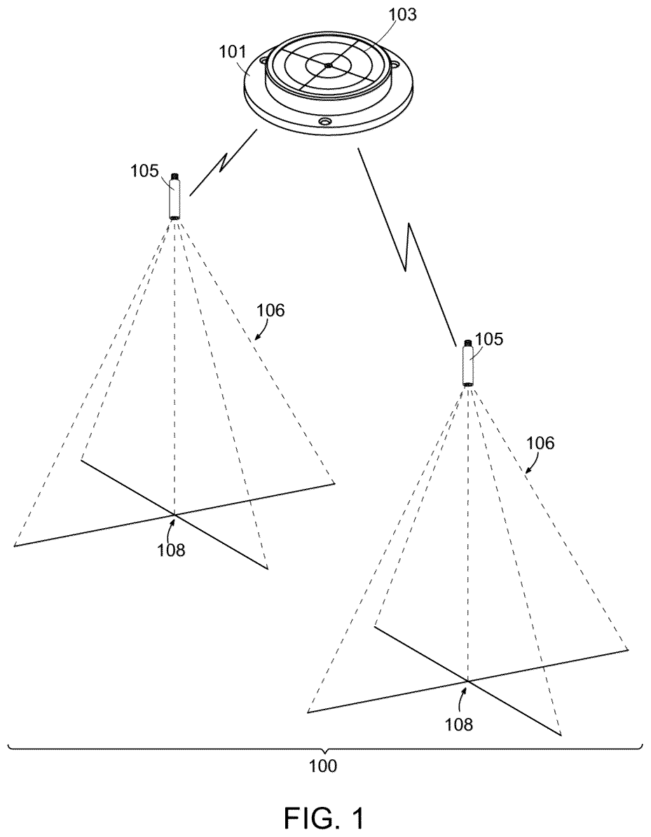

FIG. 1 is an illustration of a lift alignment apparatus 100 comprised of a level tool 101 having a display 103 and a number of crosshair projectors 105, each crosshair projector 105 emitting an emitted crosshair 106.

In the depicted embodiment, level tool 101 is a 2-dimensional level tool with a digital display 103, but other embodiments may comprise different configurations without deviating from the teachings disclosed herein. In some embodiments, level tool 101 may comprise a 2-dimensional bubble level without deviating from the teachings disclosed herein. In the depicted embodiment, digital level 101 advantageously may comprise additional features to be in wireless data communication with each of crosshair projectors 105. This data communication may permit a user to utilize human-machine interface (HMI) features (not shown) of level 101 to control features of the level 101 and each of the crosshair projectors 105. Additionally, the data communication may permit level 101 to illustrate current power levels of batteries of each of crosshair projectors 105 via display 103. In the depicted embodiment, level 101 comprises a high-precision 2-dimensional level, with an accuracy within less than 1-degree of tilt. Some embodiments may comprise even greater accuracy, such as an accuracy within less than 0.25-degrees of tilt, without deviating from the teachings disclosed herein.

Each of crosshair projectors 105 in the depicted embodiment comprise a laser crosshair projector, which emits a laser crosshair 106 for alignment uses when activated. The emitted crosshair 106 projects linear laser lines in 2 orthogonal directions, intersecting at the center point of each emitted line to form a crosshair 108 when projected onto a surface. In the depicted embodiment, alignment apparatus has a pair of crosshair projectors 105, but other embodiments may comprise a different number without deviating from the teachings disclosed herein.

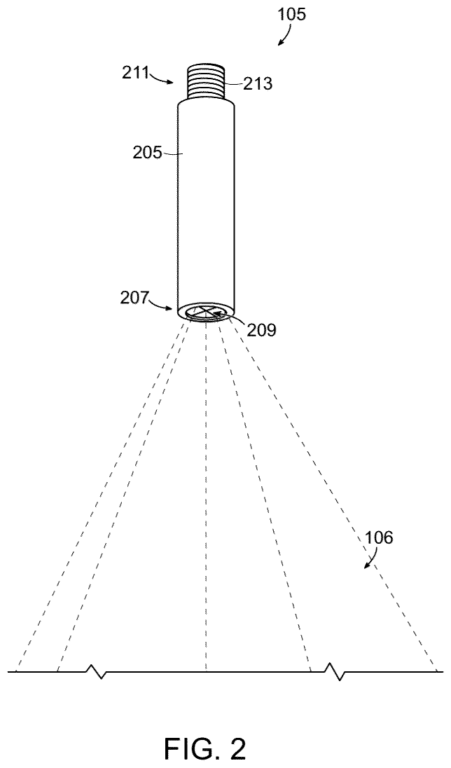

FIG. 2 is a close-up illustration of a crosshair projector 105. Crosshair projector 105 comprises a body 205 housing the emission components (not shown) of the laser emitters. In the depicted embodiment, crosshair projector 105 comprises a cylindrical body 205, but other embodiments may comprise other configurations having different shapes without deviating from the teachings disclosed herein.

Body 105 comprises an emission portion 207 including an emission port 209 through which the emitted crosshair 106 is projected. At the opposite end of body 105 is a mounting portion 211, which is configured to mount onto a battery lift, onto a peripheral region of a vehicle battery, or onto a vehicle chassis during an alignment. Mounting portion 211 comprises a coupling mechanism 213 to accomplish the coupling of crosshair projector 105 with a battery lift, vehicle battery, or vehicle chassis. In the depicted embodiment, coupling mechanism 213 comprises a screw thread and a magnetic insert to maximize compatibility with a variety of mounting points during an alignment process, but other embodiments may comprise a different configuration having only one of the screw thread, magnetic insert, or a different coupling mechanism without deviating from the teachings disclosed herein.

The screw thread of coupling mechanism 213 advantageously matches the threading specified for a vehicle battery used to secure the vehicle battery within the chassis of a vehicle or onto a battery lift. This advantageously maximizes the compatibility of coupling mechanism 213 with a variety of components used during a lift alignment for maximum flexibility to the user to position the crosshair projector 105 in a variety of circumstances. In some embodiment, a thread coupling adapter (not shown) may be utilized to permit the coupling of crosshair projector 105 with a screw receptacle of a different threading dimension.

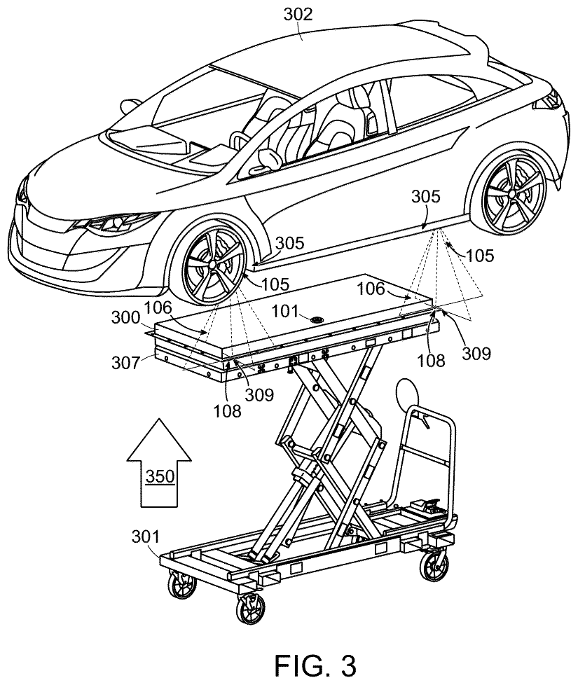

FIG. 3 depicts a battery lift alignment during a transfer of a electric vehicle battery (EVB) 300 from a battery lift 301 into a vehicle chassis 302. In this embodiment, crosshair projectors 105 are each positioned at an emitter locus 305 of vehicle chassis 302. In this depiction, the emitter loci 305 correspond with a fastening point of the vehicle to secure EVB 300 when fully mounted. In this depiction, crosshair projectors may be screwed into threaded slots utilizing coupling mechanism 213, but other embodiments may comprise other configurations without deviating from the teachings disclosed herein.

Battery lift 301 comprises a planar support surface 307 compatible to support EVB 300, including providing sufficient support for the weight of the EVB as well as sufficient surface area to support the dimensions of EVB 300 securely. In the depicted embodiment, planar support surface 307 is effectively the same width and length as EVB 300, but other embodiments may comprise different configurations having different dimensions, orientations, or shapes without deviating from the teachings disclosed herein. Battery lift 301 further is configured such that planar support surface 307 is height-adjustable in a direction 350 perpendicular to planar support surface 307. This enables battery lift 301 to be positioned relative to vehicle chassis 302 such that the EVB is safe to transfer to or from either the battery lift 301 or the vehicle chassis 302.

In this depiction, EVB 300 is resting upon planar support surface 307 of battery lift 301, indicating that the transfer of EVB 300 will be from the battery lift 301 as an origin to the vehicle chassis 403 as destination. However, reversing the origin and destination does not deviate from the teachings herein, and the alignment apparatus remains useful in the reverse transfer.

During an alignment of the battery lift 301 to vehicle chassis 302, the emitted crosshairs 106 project a crosshair 108 onto target loci 309 of EVB 300. In this depiction, each target locus 309 corresponds to a fastening point for EVB 300, which advantageously will align with the fastening point of emitter locus 305 when EVB 300 is properly aligned and in close proximity to vehicle chassis 302. In order to ensure proper alignment, a user can utilize level 101 to ensure that planar support surface 307 is properly even and level, and then battery lift 301 can be positioned such that each of crosshairs 108 aligns with a corresponding target locus 309. Once battery lift 301 is aligned, EVB 300 can be raised along direction 350 until EVB 300 is in sufficiently close proximity to vehicle chassis 302 such that the EVB 300 is transferrable between the vehicle chassis 302 and battery lift 301. Once in position, each crosshair projector 105 may be removed, and the battery 300 can be transferred, including fastening the EVB 300 to the vehicle chassis 302 at designated points.

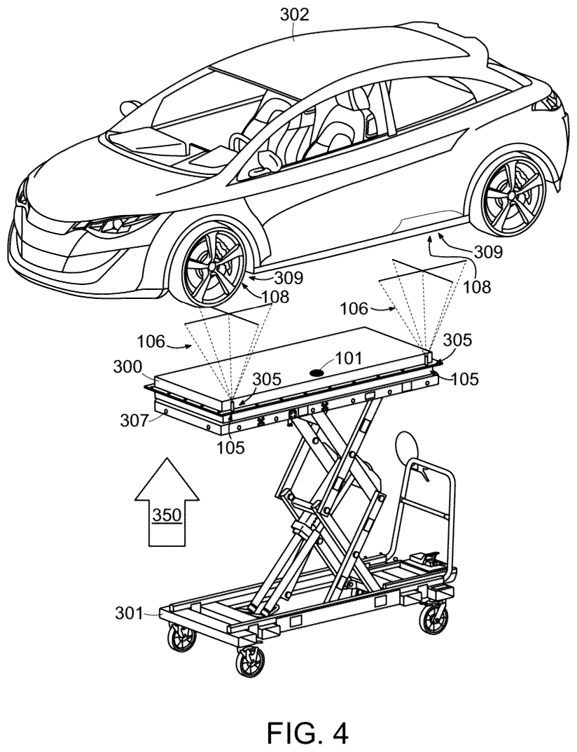

FIG. 4 depicts a battery lift alignment during a transfer of an EVB 300 from a battery lift 301 into a vehicle chassis 302. This embodiment contrasts with the arrangement depicted in FIG. 3 because the crosshair projectors 105 are each positioned at an emitter locus 305 of battery lift 301, rather than of the vehicle chassis 302. In this depiction, the emitter loci 305 correspond with fastening points of the battery lift 301 to secure EVB 300. In this depiction, crosshair projectors 105 may be magnetically coupled to each emitter locus 305 when inserted into the fastening point, utilizing coupling mechanism 213, but other embodiments may comprise other configurations without deviating from the teachings disclosed herein.

In this depiction, EVB 300 is resting upon a planar support surface 307 of battery lift 301, indicating that the transfer of EVB 300 will be from the battery lift 301 as an origin to the vehicle chassis 403 as destination. However, reversing the origin and destination does not deviate from the teachings herein, and the alignment apparatus remains useful in the reverse transfer.

During an alignment of the battery lift 301 to vehicle chassis 302, the emitted crosshairs 106 project a crosshair 108 onto target loci 309 of vehicle chassis 302. In this depiction, each target locus 309 corresponds to a fastening point for EVB 300, which advantageously will align with the fastening point of emitter locus 305 when electric lift 301 is properly aligned and in close proximity to vehicle chassis 302. In order to ensure proper alignment, a user can utilize level 101 to ensure that planar support surface 307 is properly even and level, and then battery lift 301 can be positioned such that each of crosshairs 108 aligns with a corresponding target locus 309. Once battery lift 301 is aligned, EVB 300 can be raised along direction 350 until EVB 300 is in sufficiently close proximity to vehicle chassis 302 such that the EVB 300 is transferrable between the vehicle chassis 302 and battery lift 301. Once in position, each crosshair projector 105 may be removed, and the battery 300 can be transferred, including fastening the EVB 300 to the vehicle chassis 302 at designated points.

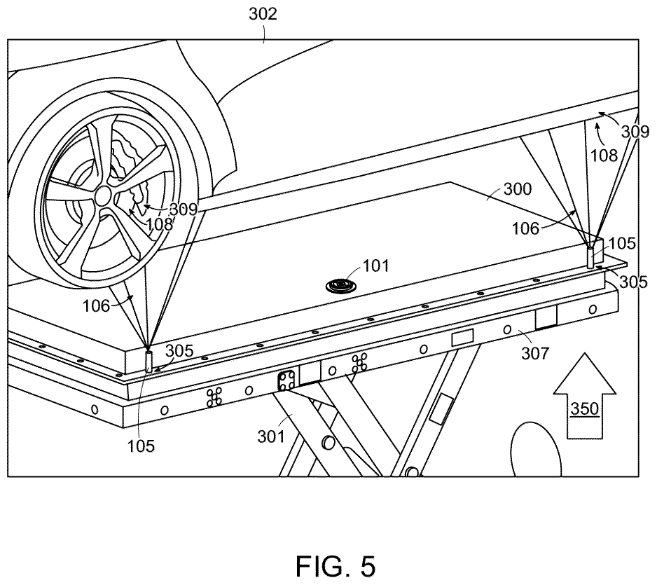

FIG. 5 provides an additional close-up view of the arrangement depicted in FIG. 4. In this depiction, it can be observed that each of crosshairs 108 will align with one the target loci 309 of vehicle chassis 302.

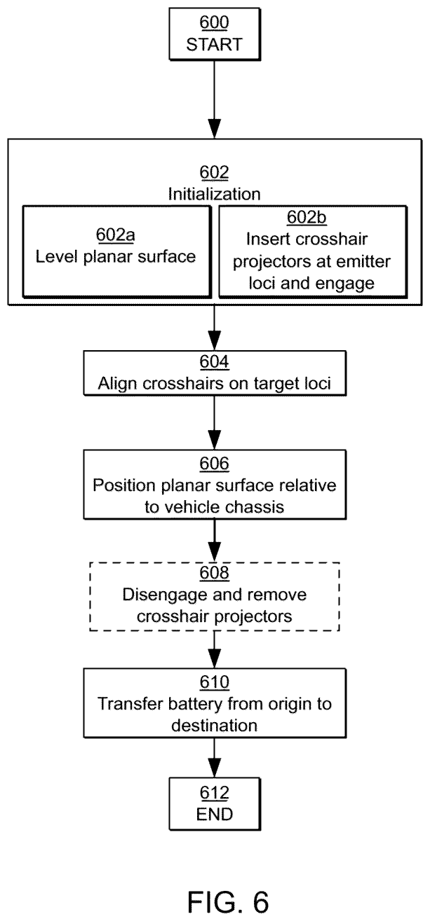

FIG. 6 is a flowchart illustrating a method of utilizing an alignment apparatus (such as lift alignment apparatus 100; see FIG. 1). The method begins at step 600 and proceeds to step 602 where a number of sub-steps are performed during the initial setup of the alignment. At sub-step 602a, a planar surface of a battery lift (such as planar surface 307; see FIG. 3) is placed into a level condition using a level tool (such as level tool 101; see FIG. 1). At sub-step 602b one or more crosshair projectors (such as crosshair projectors 105; see FIG. 1) are each placed at a corresponding emitter locus of an origin for the battery during the transfer. In transfers between a vehicle chassis (such as vehicle chassis 302; see FIG. 3) and a battery lift (such as battery lift 301; see FIG. 1), the battery (such as EVB 300; see FIG. 3) is transferred from an origin to a destination. Because transfers occur at the beginning and end of service to the electric vehicle, the origin may comprise the vehicle or the battery lift without deviating from the teachings disclosed herein. The emitter loci may comprise a pre-determined locus or loci of the origin (such as the emitter loci 305 of battery 301; see FIG. 5) or advantageously the crosshair projectors may utilize fastening points for the battery (such as emitter loci 305; see FIG. 3, FIG. 4). In some embodiments, the crosshair projectors may be secured by a coupling mechanism (such as coupling mechanism 213; see FIG. 2). By way of example, and not limitation, the coupling mechanism may comprise a screw thread matching a corresponding screw of the emitter locus, or a magnetic coupling mechanism without deviating from the teachings disclosed herein.

Each of the sub-steps of step 602 may be completely consecutively, at least partially concurrently, or simultaneously without deviating from the teachings disclosed herein. The substeps of step 602 may completed in any order without deviating from the teachings disclosed herein.

After the initialization of step 602 is complete, the crosshair projectors have been placed at the emitter loci and the planar surface is rendered level. In this condition, the emitted crosshairs of the crosshair projectors will provide a user with a visual reference for alignment when aligned to one or more target loci of the destination (such as target loci 309; see FIG. 3, FIG. 4, FIG. 5). In some embodiments, the target loci may comprise fastening points for the battery at the destination, but other embodiments may comprise a different set of designated positions, markings, or other indicators on the destination without deviating from the teachings disclosed herein.

At step 604, the emitted crosshairs (such as crosshairs 108; see FIG. 1, FIG. 3, FIG. 4, FIG. 5) will each be concurrently projected onto their corresponding target loci of the destination. When this is accomplished, it means alignment has been completed, and the battery can be placed in proximity to the destination for a successful transfer. In most arrangements, this will mean in practice that a battery lift is raised to be near to the vehicle chassis, but other embodiments may move the vehicle chassis without deviating from the teachings disclosed herein. Positioning of the planar surface of the lift is accomplished at step 606, and prior to transfer of the battery from the origin to the destination, an additional step 608 may remove the crosshair projectors and level tool from the working environment in order to prevent their presence from interfering with the transfer or causing damaged to any component of the battery, the battery lift, the vehicle, or the instruments themselves. In some embodiments, the placement of crosshair projectors and level tool will not be configured to obstruct with the transfer, and in such embodiments step 608 may be omitted or optional without deviating from the teachings disclosed herein.

Once the planar surface of the battery lift is a position of suitably close proximity to enable the transfer of the battery from the origin to the destination, this transfer is accomplished at step 610. In some transfers, the battery is further secured to the destination utilizing one or more fastening mechanisms (such as screws, bolts, clamps, latches, or the like) in order to prevent any unwanted shifting of the battery at the destination. In embodiments in which the battery has been removed from the vehicle, the vehicle chassis serves as the origin and the battery lift serves as the destination, and the battery is transferred from the vehicle chassis to the battery lift. In other embodiments in which the battery is installed into a vehicle, the battery lift serves as origin and the vehicle chassis serves as destination, and the battery is transferred from the battery lift into the vehicle chassis.

In most embodiments, step 608 results in a placement such the destination is in direct contact with at least one surface of the battery for transfer, but other embodiments may proceed to step 610 under different conditions without deviating from the teachings disclosed herein. Optimal conditions for a battery transfer may be specified by a manufacturer of a vehicle, a battery, or a battery lift without deviating from the teachings disclosed herein.

Once the battery has been transferred, the method ends at step 612.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A method of transferring an electric vehicle battery (EVB) between a vehicle chassis and a battery lift, wherein the method comprising:
leveling a planar support surface of the battery lift;
inserting each of a plurality of crosshair projectors into an emitter locus, each of the emitter loci corresponding to a designated alignment position of the EVB;
aligning the battery lift relative to the vehicle chassis such that each emitted crosshair from each of the plurality of crosshair projectors aligns to a corresponding target locus for the EVB concurrently;
moving the planar support surface relative to the vehicle chassis such that the EVB is transferrable between the vehicle chassis and the battery lift; and
transferring the EVB to the battery lift.

2. The method of claim 1, wherein each of the plurality of crosshair projectors are inserted into a emitter locus of the battery lift, and each of the emitted crosshairs are aligned with a target locus of the vehicle chassis.

3. The method of claim 1, wherein each of the plurality of crosshair projectors are inserted into a emitter locus of the vehicle chassis, and each of the emitted crosshairs are aligned with a target locus of the battery lift.

4. The method of claim 1, wherein the leveling the planar support surface utilizes a 2-dimensional level tool.

5. The method of claim 1, wherein the inserting of the crosshair projector into the emitter locus utilizes a magnetic coupling between the crosshair projector and the emitter locus.

6. The method of claim 1, wherein the inserting of the crosshair projector into the emitter locus utilizes a threaded coupling between the crosshair projector and the emitter locus.

7. A method of transferring an electric vehicle battery (EVB) between a battery lift and a vehicle chassis, wherein the method comprising:
leveling a planar support surface of the battery lift;
inserting each of a plurality of crosshair projectors into an emitter locus, each of the emitter loci corresponding to a designated alignment position of the EVB;
aligning the battery lift relative to the vehicle chassis such that each emitted crosshair from each of the plurality of crosshair projectors aligns to a corresponding target locus for the EVB concurrently;
moving the planar support surface relative to the vehicle chassis such that the EVB is transferrable between the vehicle chassis and the battery lift; and
transferring the EVB to the vehicle chassis.

8. The method of claim 7, wherein each of the plurality of crosshair projectors are inserted into a emitter locus of the battery lift, and each of the emitted crosshairs are aligned with a target locus of the vehicle chassis.

9. The method of claim 7, wherein each of the plurality of crosshair projectors are inserted into a emitter locus of the vehicle chassis, and each of the emitted crosshairs are aligned with a target locus of the battery lift.

10. The method of claim 7, wherein the leveling the planar support surface utilizes a 2-dimensional level tool.

11. The method of claim 7, wherein the inserting of the crosshair projector into the emitter locus utilizes a magnetic coupling between the crosshair projector and the emitter locus.

12. The method of claim 7, wherein the inserting of the crosshair projector into the emitter locus utilizes a threaded coupling between the crosshair projector and the emitter locus.

13. A lift alignment apparatus comprising:
a level tool; and
a crosshair projector,
wherein
the level tool is a 2-dimensional level tool,
the crosshair projector has a body with an emission portion and a mounting portion disposed opposite from the emission portion, and
the mounting portion has coupling mechanism compatible with a mounting portion of a battery lift.

14. The lift alignment apparatus of claim 13, wherein the crosshair projector is a first crosshair projector of a plurality of crosshair projectors.

15. The lift alignment apparatus of claim 13, wherein the coupling mechanism comprises a threaded coupling.

16. The lift alignment apparatus of claim 13, wherein the coupling mechanism comprises a magnetic coupling.

17. The lift alignment apparatus of claim 13, further comprising a battery lift having a number of mounting portions disposed about a planar support surface, wherein
the planar support surface is compatible to support an electric vehicle battery (EVB),
the planar support surface is height-adjustable in a direction perpendicular to the planar support surface, and
each of the mounting portions is compatible with the coupling mechanism of the crosshair projector.

18. The lift alignment apparatus of claim 17, wherein at least one of the mounting portions comprises a magnetic coupler.

19. The alignment apparatus of claim 17, wherein at least one of the mounting portions comprises a threaded coupler.

20. The alignment apparatus of claim 17, wherein each mounting portion of the battery lift is disposed in alignment with a peripheral portion of an electric vehicle battery (EVB) when the EVB is supported by the battery lift.
